(19) United States
(12) Patent Application Publication
(10) Pub. No.: US 2022/0206186 A1
(43) Pub. Date: Jun. 30, 2022

(54) HYBRID METASURFACE-REFRACTIVE SUPER SUPERACHROMATIC LENSES

(71) Applicant: PRESIDENT AND FELLOWS OF HARVARD COLLEGE, Cambridge, MA (US)

(72) Inventors: Wei-Ting CHEN, Cambridge, MA (US); Federico CAPASSO, Cambridge, MA (US); Kerolos M. A. YOUSEF, Giza (EG); Yousef A. IBRAHIM, Waterdown (CA)

(73) Assignee: PRESIDENT AND FELLOWS OF HARVARD COLLEGE, Cambridge, MA (US)

(21) Appl. No.: 17/603,904

(22) PCT Filed: Apr. 14, 2020
(86) PCT No.: PCT/US2020/028159

§ 371 Date: Oct. 14, 2021

Related U.S. Application Data
(60) Provisional application No. 62/834,344, filed on Apr. 15, 2019.

(51) Int. Cl. G02B 1/00

(52) U.S. Cl. CPC G02B 1/002

(57) ABSTRACT

An optical device includes a substrate, a single-layer metasurface disposed on the substrate, and a refractive lens. The metasurface and the refractive lens may be configured to bring at least five distinct wavelengths to focus on a same plane.

### CROSS-REFERENCE TO RELATED APPLICATIONS

The present application claims the benefit of and priority to U.S. Provisional Application No. 62/834,344, filed Apr. 15, 2019, which is hereby incorporated by reference herein in its entirety.

### STATEMENT OF FEDERALLY SPONSORED RESEARCH

This invention was made with Government support under FA9550-14-1-0389 and FA9550-16-1-0156, awarded by Air Force Office of Scientific Research, and under HR00111810001, awarded by the Defense Advanced Research Projects Agency. The Government has certain rights in the invention.

### BACKGROUND

The refractive index of natural materials varies with wavelength. This may result in dispersion, which introduces chromatic aberration in refractive lenses. A comparative approach to solve this problem, which has been in use for hundreds of years, is based on stacking multiple lenses made of different glass materials. The choice of these lens materials in order to achieve ultra-broadband achromaticity has relied on a brute force optimization process using ray-tracing software.

Chromatic aberration is the failure of a lens to focus all wavelengths of light to the same point. It therefore leads to image blurring and a reduction of spatial resolution. In the 1730s, flint and crown glass lenses were first used to make doublet lenses in order to mitigate the effects of chromatic aberration. However, the manufacturing of these doublets was troubled by of various defects, which prevented high quality imaging. About a hundred years later, high quality glass lenses were realized by Zeiss, Abbe and Schott. It was noticed that if lenses were made with two glass materials, there would still be significant residual chromatic aberrations. One solution is to add more lenses comprising other glass materials. This led to the research and development of different glasses. Nowadays, the choice of available glasses is still very limited to about 120 types, indicating that the development of new glass is very challenging and time consuming.

Modern camera lenses and microscope objectives are usually apochromatic, in that three distinct wavelengths are brought to the same focal plane within a given bandwidth. In 1963, Herzberger and his co-workers in Zeiss Inc. proposed for the first time a superachromatic lens with four wavelengths focused in the same plane in the visible. However, the design is complicated and includes special materials, such as fluoride glasses. Due to the limited choice of glasses, these designs are not readily transferred to other wavelength regions, and may be limited with regard to how much they reduce residual chromatic aberration.

### SUMMARY

Herein is shown that a metasurface working in tandem with a refractive component can significantly reduce or substantially eliminate chromatic aberrations in any frequency region of interest from the ultra-violet to the midinfrared (including over the visible spectrum), resulting in an unprecedented super superachromatic and super super superachromatic hybrid lenses with tunable bandwidths. The generality of the method makes it a useful tool for the design of hybrid lenses with revolutionary performance and compactness.

Here, insights into the design of optimal glass materials for broadband achromatic lenses are disclosed, as are metasurfaces composed of subwavelength nanostructures to reduce or substantially eliminate chromatic aberrations. Herein is shown how superachromatic focusing can be realized by using a single-layer metasurface and a refractive doublet lens (e.g., made of common glasses). This same design principle allows for further designing a super superachromatic and super superachromatic lenses with an unprecedented performance of bringing five and six distinct wavelengths to focus on the same plane, respectively. Some embodiments have an achromatic and diffraction-limited bandwidth from the ultra-violet to the short mid-infrared (from about 350 nanometers (nm) wavelength to about 2500 nm wavelength). Some embodiments are superior compared to comparative approaches at least in that the metasurface provides a way to simultaneously impart the desired phase and dispersion to incident light with minimal added bulk and alignment complexity. Some embodiments provide for apochromat hybrid lenses comprising a metasurface and a single refractive lens for the near-infrared. This can be applied to even the mid- and far-infrared regions.

At least one aspect of the present disclosure relates to an optical device including a substrate, a single-layer metasurface disposed on (e.g., formed/fabricated on, or formed fabricated using part of, fused on, and/or located on) the substrate, and a refractive lens. The single-layer metasurface and the refractive lens are configured to bring at least five distinct wavelengths of light to focus on a same plane.

In some embodiments, the single-layer metasurface and the refractive lens are configured to bring at least six distinct wavelengths of light to focus on the same plane. In some embodiments, the single-layer metasurface and the refractive lens are configured to bring the at least five distinct wavelengths of light to focus on the same plane, at least along an optical axis of the refractive lens and/or off the optical axis of the refractive lens and/or the metasurface. In some embodiments, the refractive lens includes a glass, and the glass is free of (or substantially free of) fluoride. In some embodiments, the refractive lens includes a plastic. In some embodiments, a material of the lens is different from a material of the metasurface (and/or the substrate). In some embodiments, a material of the refractive lens has zero n′_{g} over a wavelength range of interest and the single-layer metasurface minimizes group delay and group delay dispersion. In some embodiments, the at least five distinct wavelengths are in at least one of an infrared spectrum, a visible spectrum, or an ultraviolet spectrum (e.g., the at least five distinct wavelengths are in one of, or any combination of two or more of: an infrared spectrum, a visible spectrum, an ultraviolet spectrum). In some embodiments, the refractive lens comprises at least one of a singlet lens or a doublet lens.

Another aspect of the present disclosure relates to an optical device including a substrate, a metasurface disposed on the substrate, and a lens. The metasurface and the lens are configured to provide super superachromatic focusing.

In some embodiments, the metasurface and the lens are configured to provide super superachromatic focusing. In some embodiments, the metasurface and the lens are configured to bring at least five distinct wavelengths of light to focus on a same plane. In some embodiments, the metasurface and the lens are configured to provide super superachromatic focusing at least along an optical axis of the lens (e.g., on-axis) or off the optical axis of the lens (e.g., off-axis, transverse). In some embodiments, a material of the lens is different from a material of the metasurface. In some embodiments, the at least five distinct wavelengths are in at least one of an infrared spectrum, a visible spectrum, or an ultraviolet spectrum. In some embodiments, the metasurface and the lens are configured to bring at least six distinct wavelengths of light to focus on a same plane. In some embodiments, the lens includes a glass, and the glass is free of (or substantially free of) fluoride. In some embodiments, the lens includes a plastic. In some embodiments, the lens comprises a singlet lens. In some embodiments, the lens comprises a doublet lens.

### BRIEF DESCRIPTION OF THE DRAWINGS

For a better understanding of the nature and objects of some embodiments of this disclosure, reference should be made to the following detailed description taken in conjunction with the accompanying drawings.

FIG. 1(a) and FIG. 1(b) show a layout and principle of achromatic refractive-metasurface lenses according to some embodiments.

FIG. 2(a), FIG. 2(b), and FIG. 2(c) show apochromatic refractive-metasurface lens with large field of view, according to some embodiments.

FIG. 3(a), FIG. 3(b), FIG. 3(c), and FIG. 3(d) show examples of selecting suitable glasses, according to some embodiments.

FIG. 4(a), FIG. 4(b), FIG. 4(c), FIG. 4(d), FIG. 4(e), and FIG. 4(f) show design and performance of superachromatic and super superachromatic hybrid lenses, according to some embodiments.

FIG. 5(a) and FIG. 5(b) show dispersion profiles of the metasurfaces shown in FIG. 3, according to some embodiments.

FIG. 6(a) and FIG. 6(b) show tunable achromatic bandwidths, according to some embodiments.

FIG. 7(a), FIG. 7(b), and FIG. 7(c) show design and performance of a super super superachromatic hybrid lens, according to some embodiments.

FIG. 8 show certain dispersion profiles of the metasurface shown in FIGS. 7(a)-7(c), according to some embodiments.

### DETAILED DESCRIPTION

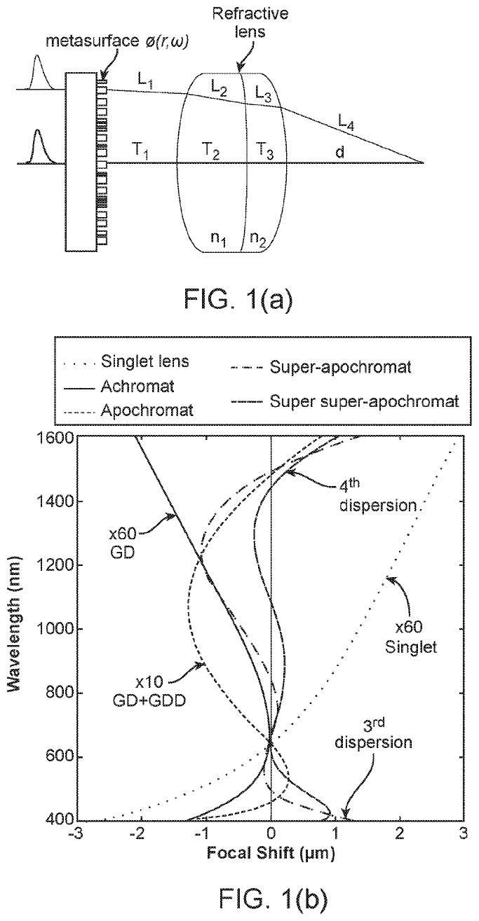

Some approaches disclosed herein are unique compared to comparative methods, which involve solving simultaneous equations using Abbe numbers of glasses. FIG. 1(a) and FIG. 1(b) show a layout and principle of achromatic refractive-metasurface lenses according to some embodiments. FIG. 1(a) shows a schematic layout of a refractive-metasurface lens. The hybrid lens comprises a single-layer metasurface and a refractive element. The single-layer metasurface can comprise or form (e.g., be part of) a metalens of any type. The refractive element can be either a doublet or a singlet lens, or can include both of these types of lenses. FIG. 1(b) shows a principle of achromatic focusing. The role of the metasurface is to impart tailored dispersion profiles to incident light. This compensates for, and in some cases eliminate, the chromatic aberration resulting from material dispersion. For a singlet lens, if the metasurface can provide a correction up to the group delay dispersion (second order derivative of phase with respect to frequency), the hybrid lens shows apochromatic focusing and the focal length shift is improved by an order of magnitude. Unprecedented super super-achromatic focusing is possible if the metasurface can provide a correction up to the 4^{th} order dispersion profile (Eq. 5).

FIG. 1(a) shows a typical layout of a hybrid system (e.g., optical device) according to some embodiments, including a metasurface and a refractive lens element. The optical device can include a substrate, a single-layer disposed on the substrate, and a refractive lens. The single-layer metasurface and the refractive lens can be configured to bring at least five distinct wavelengths of light to focus on a same plane. For example, the single-layer metasurface and the refractive lens are configured to bring at least six distinct wavelengths of light to focus on a same plane. The refractive element could be a singlet or a doublet lens depending on how many dispersion terms are to be fulfilled. The incident light is treated as wavepackets. The metasurface working in tandem with the doublet may ensure all wavepackets are propagating towards the focus and arrive at substantially the same time with a substantially identical temporal profile. The single-layer metasurface and the refractive lens can be configured to bring the at least five distinct wavelengths of light to focus on the same plane along an optical axis of the refractive lens or off the optical axis of the refractive lens and/or the metasurface (or metalens). For example, the single-layer metasurface and the refractive lens can reduce axial chromatic aberration and/or transverse chromatic aberration. Axial chromatic aberration can occur along the optical axis of the refractive lens. Transverse chromatic aberration can office off the optical axis of the refractive lens. To deflect incident wavepackets towards the focus, the metasurface imparts a phase profile at a given design angular frequency ω_{d} corresponding to the criteria for diffraction-limited focusing:

$$φ ( r , {ω}_{d} ) = \frac{{ω}_{d}}{c} ( {T}_{1} + d - {L}_{1} - {L}_{4} ) + \frac{{ω}_{d}}{c} {n}_{1} ( {ω}_{d} ) \cdot ( {T}_{2} - {L}_{2} ) + \frac{{ω}_{d}}{c} {n}_{2} ( {ω}_{d} ) \cdot ( {T}_{3} - {L}_{3} ) \qquad ( Eq . 1 )$$

where T, f and L are path lengths schematically depicted in FIG. 1a and r is the radial coordinate of the metasurface. Subsequently, to ensure these wavepackets arrive substantially simultaneously, the following equation is satisfied:

$$\frac{\partial φ}{\partial ω} = \frac{( {T}_{1} + d - {L}_{1} - {L}_{4} )}{c} + \frac{( {T}_{2} - {L}_{2} )}{c} {n}_{{g}_{1}} ( {ω}_{d} ) + \frac{( {T}_{3} - {L}_{3} )}{c} {n}_{{g}_{2}} ( {ω}_{d} ) \qquad ( Eq . 2 )$$

where, for instance, n_{g}(ω_{d}) represents the group index of glass at ω_{d}. Note that

$$\frac{( {T}_{2} - {L}_{2} )}{c} {n}_{{g}_{1}} ( {ω}_{d} )$$

represents the time difference resulting from the path difference in glass 1 between a wavepacket entering at a radial coordinate r and the chief wavepacket). The second order derivative (group delay dispersion) and the remaining higher order terms govern the temporal profile of wavepackets and are given by

$$\begin{matrix}\frac{{\partial }^{2} φ}{\partial {ω}^{2}} = \frac{( {T}_{2} - {L}_{2} )}{c} {n}_{{g}_{1}}^{′} ( {ω}_{d} ) + \frac{( {T}_{3} - {L}_{3} )}{c} {n}_{{g}_{2}}^{′} ( {ω}_{d} ) & ( Eq . 3 ) \\ \frac{{\partial }^{3} φ}{\partial {ω}^{3}} = \frac{( {T}_{2} - {L}_{2} )}{c} {n}_{{g}_{1}}^{″} ( {ω}_{d} ) + \frac{( {T}_{3} - {L}_{3} )}{c} {n}_{{g}_{2}}^{″} ( {ω}_{d} ) & ( Eq . 4 ) \\ \frac{{\partial }^{4} φ}{\partial {ω}^{4}} = \frac{( {T}_{2} - {L}_{2} )}{c} {n}_{{g}_{1}}^{″′} ( {ω}_{d} ) + \frac{( {T}_{3} - {L}_{3} )}{c} {n}_{{g}_{2}}^{″′} ( {ω}_{d} ) & ( Eq . 5 ) \\ \frac{{\partial }^{5} φ}{\partial {ω}^{5}} = \frac{( {T}_{2} - {L}_{2} )}{c} {n}_{{g}_{1}}^{″″} ( {ω}_{d} ) + \frac{( {T}_{3} - {L}_{3} )}{c} {n}_{{g}_{2}}^{″″} ( {ω}_{d} ) & ( Eq . 6 )\end{matrix}$$

where n_{g}′ (ω_{d}) represents, at frequency ω_{d}, the value of the first-order derivative of group index. The net effect from Eq. 1 to Eq. 6 results in a specified frequency and spatially dependent phase profile of the metasurface:

$$φ ( r , ω ) = φ ( r , {ω}_{d} ) + \frac{\partial φ}{\partial ω} ( ω - {ω}_{d} ) + \frac{{\partial }^{2} φ}{2 \partial {ω}^{2}} {( ω - {ω}_{d} )}^{2} + \frac{{\partial }^{3} φ}{6 \partial {ω}^{3}} {( ω - {ω}_{d} )}^{3} + \frac{{\partial }^{4} φ}{24 \partial {ω}^{4}} {( ω - {ω}_{d} )}^{4} + \frac{{\partial }^{5} φ}{120 \partial {ω}^{5}} {( ω - {ω}_{d} )}^{5} \qquad ( Eq . 7 )$$

From Eq. 7, one can observe that the more derivative terms the metasurface can provide, the better the achromaticity of the final hybrid lens. The term φ(r,ω_{d}) corrects monochromatic aberrations. The above example stops at the 5^{th} dispersion term since such a level of correction of chromatic aberration is often sufficient in practice. Note that each term in Eq. 7 is a function of spatial coordinate r along the metasurface. The metasurface therefore should provide different dispersion profiles to fulfill Eq. 2 to Eq. 6. FIG. 1(b) shows the performance of a hybrid metasurface-refractive singlet lens, where the metasurface is assumed to provide the correct dispersion profile up to the 4^{th} order. If the metasurface provides a suitable group delay profile (1′ order derivative of phase with respect to frequency), the hybrid lens shows a focal length shift (red curve) similar to comparative achromat doublet lenses with a single turning point and two intercepts with the vertical axis. If the metasurface simultaneously imparts the correct group delay and group delay dispersion profiles, the lens shows apochromatic focusing. This is usually the standard specification of state-of-the-art microscope objectives. Satisfying dispersion terms up to the 3^{rd} order leads to superachromatic focusing. This type of lens was first demonstrated by Zeiss in 1963; however, in the original Zeiss design, some special fluoride-containing glasses were used. Herein are disclosed techniques for realizing superachromatic, super superachromatic and even super superachromatic focusing while allowing omission of certain special glasses. This is of significant practical importance, since special glasses are difficult to manufacture and costly and work for a limited region of spectrum. Fulfilling up to 5^{th} order dispersion can lead to an ultimate achromatic lens covering substantially an entire transparent window of glass.

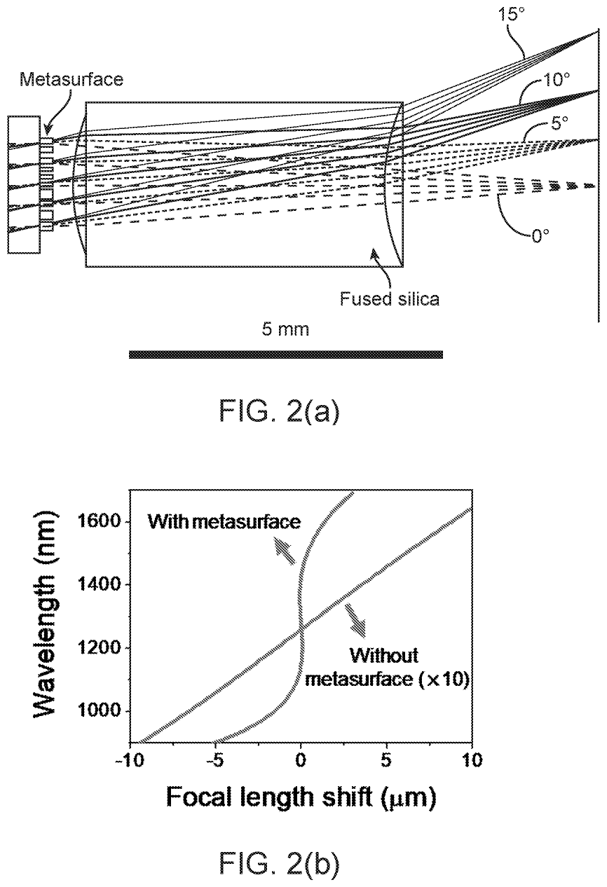

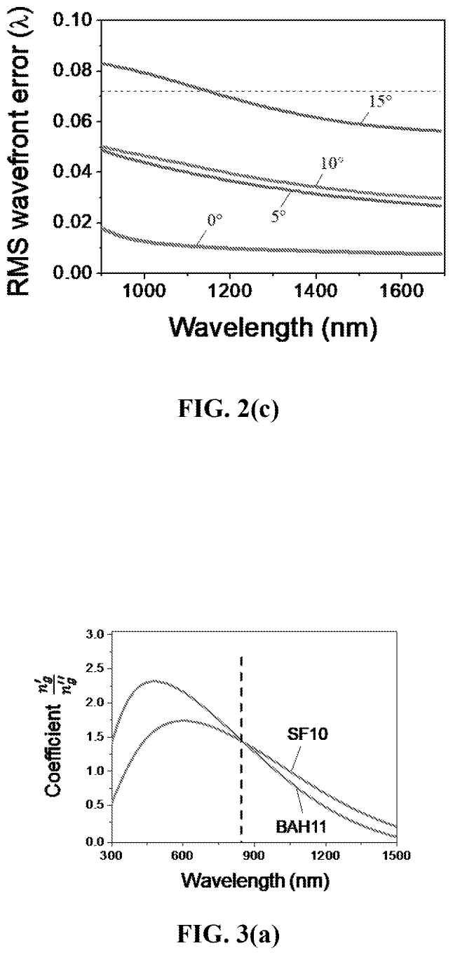

A design approach disclosed herein is applicable in a multitude of wavelength regions with distinct and unique properties in various regions. For instance, in the near-infrared, many glasses have zero n_{g}′ at the corresponding wavelength region. This immediately ensures that terms up to Eq. 3 can be minimized for apochromatic behavior. FIG. 2(a) and FIG. 2(b) show apochromatic refractive-metasurface lens with large field of view, according to some embodiments. FIG. 2(a) shows a schematic layout comprising of a metasurface and a fused silica refractive lens. The different colors of rays depict the field of view up to 15 degrees. FIG. 2(b) shows a chromatic focal length shift from 900 nm to 1700 nm. In the case with the metasurface, the focal length shift is reduced by an order of magnitude, to a few micrometers. FIG. 2(c) shows a root-mean-square wavefront errors as functions of field of view (color curves) and wavelengths. Note that although for 15 degrees field of view, the wavelengths around 900 nm result in focal spots that are slightly larger than the diffraction-limit, (dashed line), the Strehl ratio of the lens is still higher than 0.65.

FIG. 2(a) shows a hybrid metalens composed of a single fused silica lens, which provides an n_{g}′ of zero at wavelength of about 1270 nm. The role of the metasurface is to minimize the group delay values arising from the right-hand side of Eq. 2. In FIG. 2(b), without the metasurface, the chromatic focal length shift is about 200 micrometers from λ=about 900 nm to about 1700 nm, while it gets reduced by more than an order of magnitude with the metasurface. FIG. 2(c) shows wavefront errors together with the field of view of the hybrid lens. The performance of this hybrid lens (numerical aperture NA=about 0.12, diameter=about 2 mm) is nearly diffraction-limited across λ=about 900 nm to about 1700 nm within a 30 degrees field of view. The slightly larger errors for 15-degree incidence around λ=about 900 nm lowers the Strehl ratio to about 0.65. The parameters of the refractive lenses used in FIG. 2 are summarized in Table I, shown below. The same design principle is valid in the mid- or far-infrared regions where some materials have zero n_{g}′. For instance, ZnSe has n_{g}′=0 at 4.83 micrometers. The optical device can include the single-layer metasurface and the refractive lens configured to bring at least five distinct wavelengths of light to focus on a same plane. The at least five distinct wavelengths can be in at least one of an infrared spectrum, a visible spectrum, or an ultraviolet spectrum.

$$Z ( r ) = \frac{c {r}^{2}}{1 + \sqrt{1 - {c}^{2} {r}^{2}}} + {\sum }_{n = 1} {a}_{n} {r}^{2 n}$$

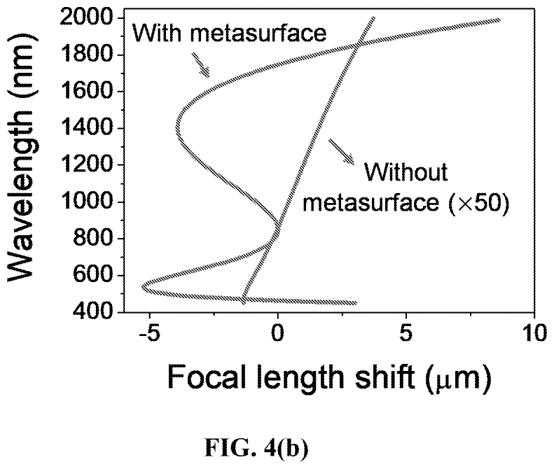

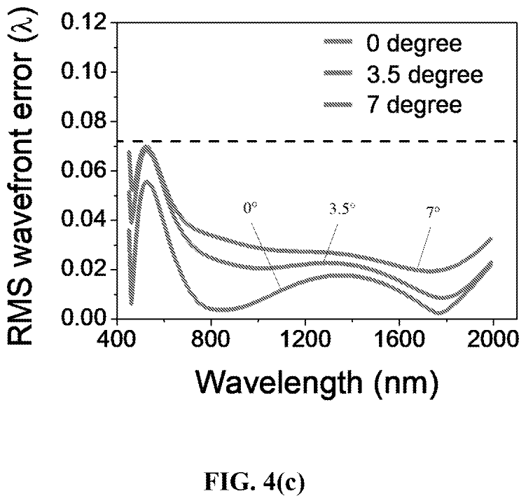

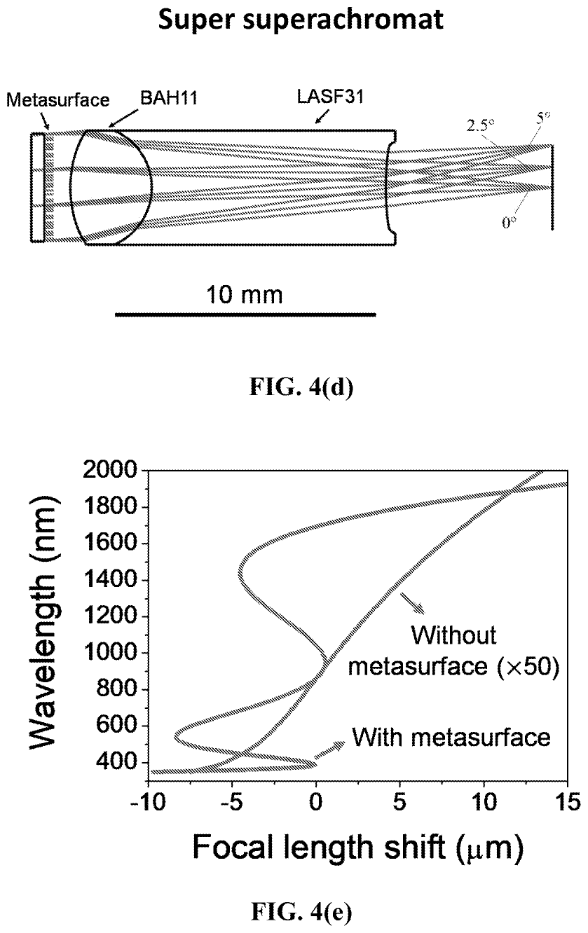

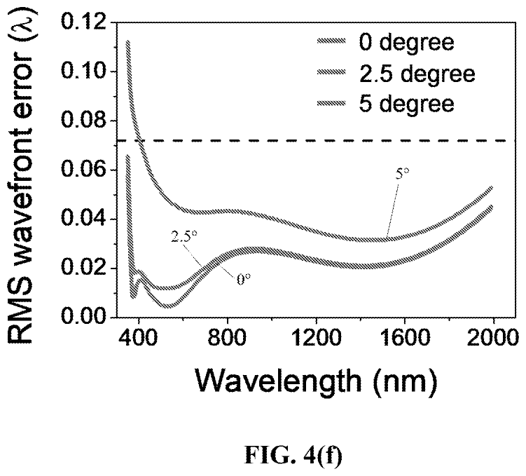

TABLE I
Summary of all refractive lenses in FIG. 2 and FIG. 4. The parameter z is the
displacement of the surface from the lens vertex, at a distance r from the lens axis.

| Superachromat | | | | Super superachromat | | | | NIR apochromatic lens | | |
|---|---|---|---|---|---|---|---|---|---|---|
| | Surface 1 | Surface 2 | Surface 3 | | Surface 1 | Surface 2 | Surface 3 | | Surface 1 | Surface 2 |
| c | 1/13.741 | −1/8.58 | 1/6.201 | c | 1/4.145 | −1/2.392 | 1/12.114 | c | 1/2.94 | −1/7.22 |
| a₁ | 0.074 | | 7.611 × 10⁻³ | a₁ | −0.013 | | −7.978 × 10⁻⁴ | a₁ | 0.025 | 0.188 |
| a₂ | 1.33 × 10⁻³ | | 0.011 | a₂ | 9.695 × 10⁻⁴ | | 5.372 × 10⁻³ | a₂ | −0.076 | 0.04 |
| a₃ | −1.57 × 10⁻⁴ | | −6.59 × 10⁻³ | a₃ | −2.67 × 10⁻⁵ | | −0.012 | a₃ | 0.292 | −0.053 |
| a₄ | 1.294 × 10⁻⁴ | | 0.021 | a₄ | 7.901 × 10⁻⁵ | | 0.026 | a₄ | −0.662 | 0.124 |
| a₅ | −5.5 × 10⁻⁵ | | −0.026 | a₅ | −1.396 × 10⁻⁵ | | −0.029 | a₅ | 0.842 | −0.163 |
| a₆ | 1.327 × 10⁻⁵ | | 0.018 | a₆ | 3.577 × 10⁻⁶ | | 0.018 | a₆ | −0.599 | 0.117 |
| a₇ | −1.674 × 10⁻⁶ | | −6.39 × 10⁻³ | a₇ | −5.945 × 10⁻⁷ | | −5.686 × 10⁻³ | a₇ | 0.22 | −0.043 |
| a₈ | 8.547 × 10⁻⁸ | | 9.245 × 10⁻⁴ | a₈ | 6.13 × 10⁻⁸ | | 7.406 × 10⁻⁴ | a₈ | −0.032 | 0.0065 |

| | | |
|---|---|---|
| 2.18-mm-thick BAH11 and | 3.12-mm-thick BAH11 and | 5 mm fused |
| 5.4-mm-thick SF10 | 9-mm-thick LASF31 | silica thickness |

The equation above describes mathematically the surface morphology of lens.

In the visible region, a doublet lens is included for optical performance better than apochromats. The material and curvature of the refractive lens should be carefully designed to minimize the specified dispersions (to make the values of the terms on the right-hand side of Eq. 2 to Eq. 6 are close to zero). The choice of glasses is particularly important. The glass library was analyzed in a well-known lens design software Zemax OpticsStudio. It has about 3,000 different glasses leading to 10 million possible combinations of glass pairs. A suitable pair of glasses was chosen by examining the ratio

$$\frac{{n}_{g}^{′}}{{n}_{g}^{″}}$$

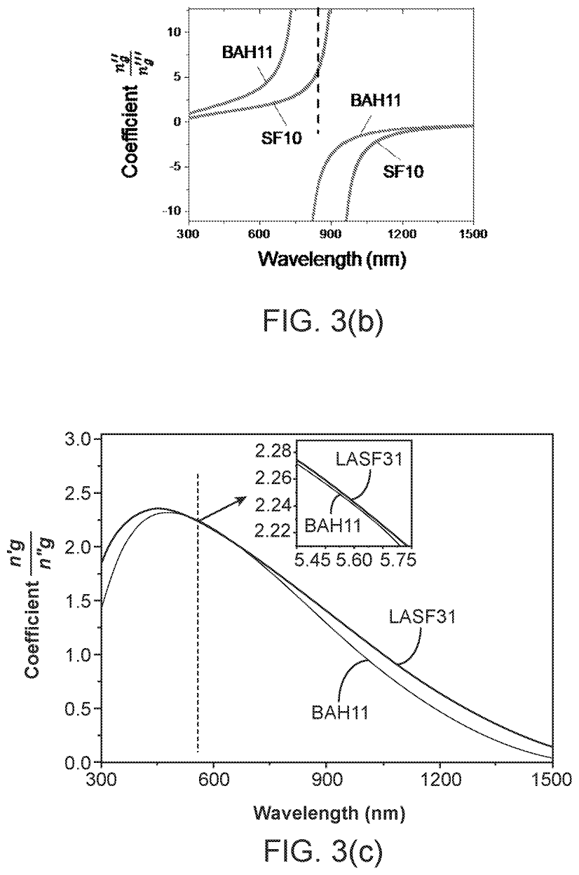

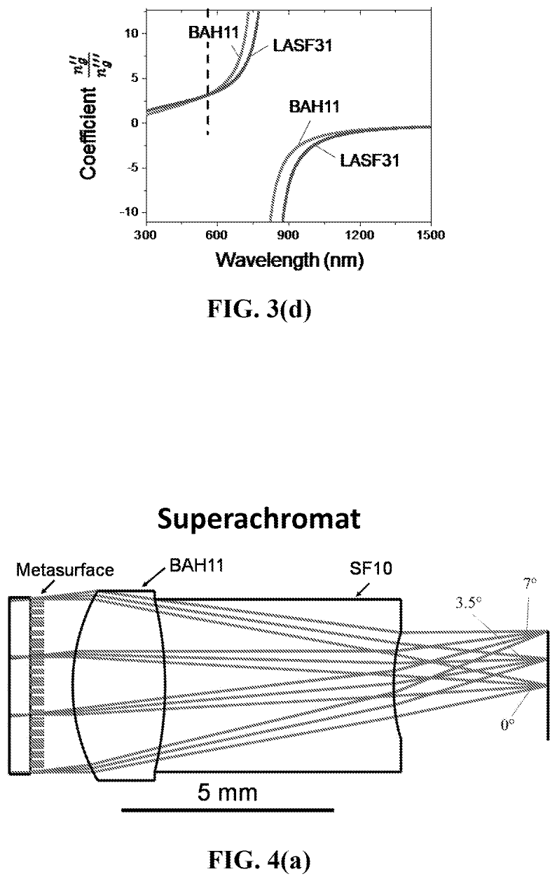

for each glass as a function of wavelength. FIG. 3(a) and FIG. 3(b) show examples of selecting suitable glasses, according to some embodiments. FIG. 3(a) and FIG. 3(b) show the ratios of derivatives of the group index for different glasses. The glass pair that comprises a doublet lens was chosen based on the existence of a point of intersection of this curve. For BAH11 and SF10, there is one such intersection shown in FIG. 3(a), which renders them viable candidates for the design of superachromatic lenses. FIG. 3(c) and FIG. 3(d) show a glass pair for super superachromatic lenses. This pair was chosen because the wavelengths of intersections in FIG. 3(c) and FIG. 3(d) are the same. Note that the difference in FIG. 3(c) is negligibly small (see the inset).

FIG. 3(a) shows an example where the plots of

$$\frac{{n}_{g}^{′}}{{n}_{g}^{″}}$$

intersect each other for the glasses BAH11 and SF10 at wavelength λ=about 856 nm. It can be mathematically verified that, if one chooses the design frequency corresponding to λ=about 856 nm for this glass pair, the right-hand sides of Eq. 3 and Eq. 4 can be simultaneously minimized. To design a metasurface that can provide up to the fourth-order dispersion, another pair of glasses whose higher order derivatives of the group index

$$\frac{{n}_{g}^{″}}{{n}_{g}^{′′′}}$$

shares the same intersection point as the previous ratio

$$\frac{{n}_{g}^{′}}{{n}_{g}^{″}}$$

can be located. This condition is more challenging to fulfill. The previous glass pair (BAH11 and SF10) does not have such an intersection for

$$\frac{{n}_{g}^{″}}{{n}_{g}^{′′′}}$$

(FIG. 3(b)). FIG. 3(c) and FIG. 3(d) show that BAH11 and LASF31 satisfy the criteria for super superachromatic focusing, discarding a negligible mismatch in its

$$\frac{{n}_{g}^{′}}{{n}_{g}^{″}}$$

(see the inset in FIG. 2(c)). Table II below shows a summary of certain glass pairs and design frequencies for superachromats and super superachromats.

TABLE II

| Super-achromat | | Super Super-achromat | |
|---|---|---|---|
| | Design | | Design |
| Materials | wavelength (nm) | Materials | wavelength (nm) |
| SF2/SF10 | 1126 | BAH11/LASF31 | 554 |
| LASF31/SF11 | 984 | LASF44/LAF164 | 536 |
| S-BAH11/SF10 | 856 | Silica/FK61 | 484 |
| S-BAL35/SF2 | 761 | | |
| LASF31/LAH64 | 635 | | |
| BAL35/Silica | 503 | | |

FIG. 4 shows design and performance of superachromatic and super superachromatic hybrid lenses, according to some embodiments. FIG. 4(a) shows a layout of superachromatic metasurface-refractive lens. FIG. 4(b) shows a focal length shift as a function of wavelength. There are four wavelengths that have the same focal length. FIG. 4(c) shows a root-mean-square wavefront error of the superachromatic metasurface-refractive lens. FIG. 4(d) shows a layout of super superachromatic metasurface-refractive lens. Such chromatic aberration correction is unprecedented in conventional refractive optics. It covers from 350 nm to 2000 nm. FIG. 4(e) shows a focal length shift with and without the metasurface. For the case without metasurface, its focal length shift is more than one order of magnitude stronger. FIG. 4(f) shows a root-mean-square wavefront error of the super superachromatic metasurface-refractive lens.

Based on the glasses chosen previously, FIG. 4(a) shows a schematic layout of a superachromatic refractive-metasurface lens. The metasurface has a diameter of 4 millimeters and the hybrid lens has a numerical aperture of 0.2. Its focal length shift is about 12 micrometers from λ=about 450 nm to about 2000 nm (FIG. 4(b)). Without the metasurface, the focal length shift is about 50 times larger. The performance of the final hybrid lens is diffraction-limited, as proven by a root-mean-square wavefront error analysis illustrated in FIG. 4(c) over 14 degrees field of view. FIG. 4(d) is a design for what can be called a super superachromatic lens of NA=0.1 and 4-millimeter diameter. Its focal length shift is about 20 micrometers from about 350 nm up to about 2000 nm (spanning an extremely large bandwidth from the ultraviolet to the near-infrared). It is worth noting that to ensure a refractive lens is achromatic in a range including λ=about 350 to about 400 nm is challenging although for the narrow about 50 nm bandwidth, because glasses become intrinsically dispersive. The wavefront error of the latter is shown in FIG. 4(f). At the short wavelength and 5 degrees angle of incidence, the wavefront error is slightly larger than the diffraction-limit. This causes a slight drop of Strehl ratio to about 0.7. The refractive lenses in FIGS. 4(a)-4(f) are aspherical.

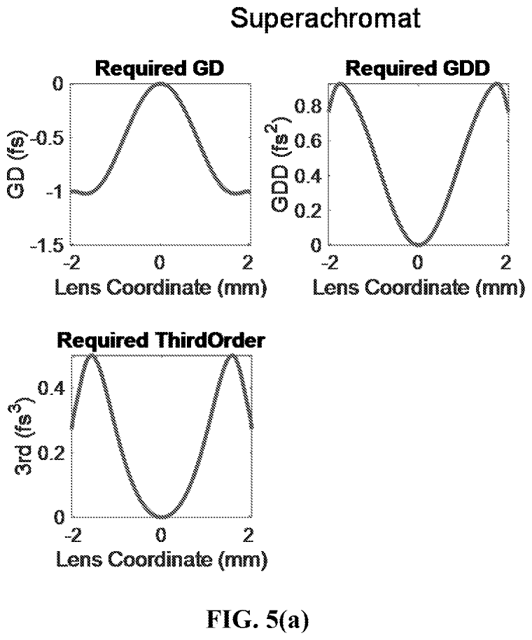

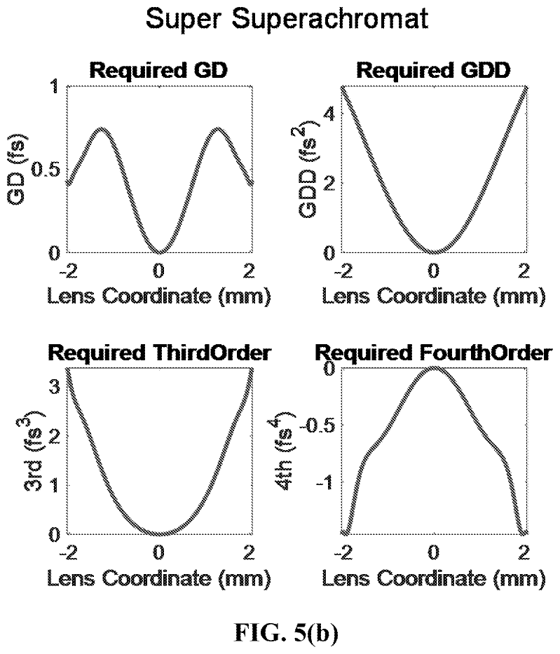

FIG. 5(a) and FIG. 5(b) shows dispersion profiles of the metasurfaces shown in FIGS. 3(a)-3(d). FIG. 5(a) shows group delay, group delay dispersion and 3^{rd} order dispersion across the center of the metasurface depicted in FIG. 3(a). FIG. 5(b) shows dispersion terms up to 4^{th} dispersion for the metasurface in FIG. 3(d).

FIG. 5(a) shows the specified group delay, group delay dispersion and the third order dispersion profiles of the superachromatic hybrid lens (FIG. 4(a)) that must/can be imparted by the metasurface. These values are small and can be fulfilled by a single layer metasurface. A metasurface comprising a single layer of TiO₂ nanostructures with 600-nm-height can provide around 5 femtoseconds and 10 femtoseconds squared of group delay and group delay dispersion, respectively. FIG. 5(b) shows the specified dispersion up to 4^{th} order for the super superachromatic hybrid lens shown in FIG. 4(d).

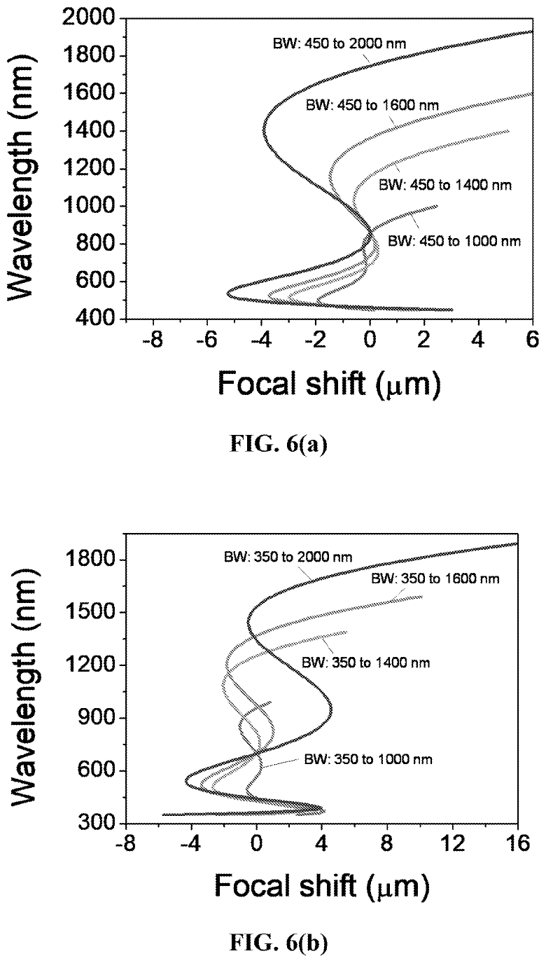

The bandwidth of achromaticity can be customized to different specifications, or “adjustable” by altering the design of metasurface dispersion profiles. FIGS. 6(a) and 6(b) shows tunable achromatic bandwidths. The superachromatic and super superachromatic focusing behaviors in FIG. 4(a) and FIG. 4(b) are tunable by controlling the dispersion profiles of the metasurfaces. The smaller bandwidth is accompanied by a weaker focal length shift. FIGS. 6(a) and 6b respectively show different bandwidths for the hybrid lenses in FIGS. 4(a) and 4b. The narrower the bandwidth, the weaker the chromatic aberration. For the case of super superachromat, the focal length shift in the curve of FIG. 6(b) shows about a 4 μm shift across about 350 nm to about 1000 nm. This result involves about 50% larger dispersion values than those shown in FIG. 5(b).

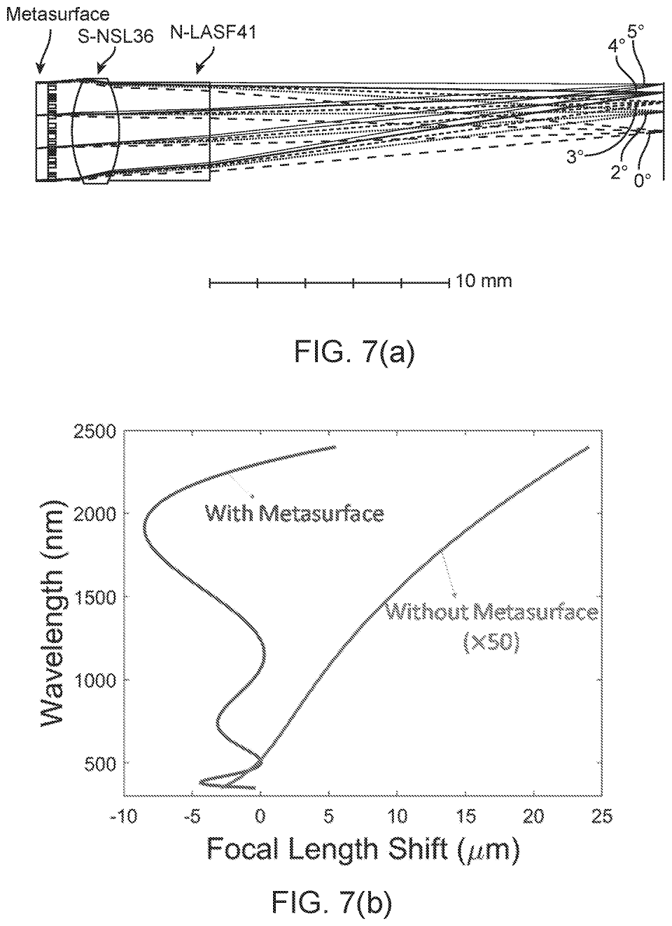

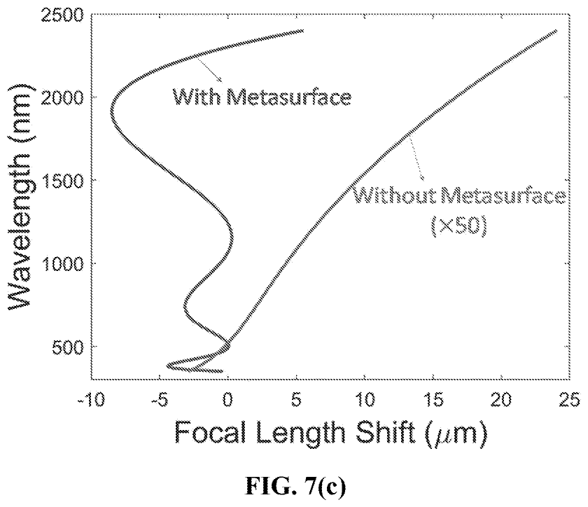

Using the trends and properties observed in the choices of superachromatic and super superachromatic glass combinations (seen in FIG. 4(a) and FIG. 4(b)), the glass selection properties can be extended to satisfy up to fifth order dispersion (Eq. 6). This leads to unprecedented super superachromatic lenses. After analyzing Zemax glass library, it was found that there are about 100 glass combinations can satisfy the previously described glass selection rule. The metalens and/or refractive lens can include various materials (e.g., selected from any library or group of materials, such as the Zemax glass library), including glasses and plastics (e.g., Polymethyl methacrylate (PMMA)). The metalens and the refractive lens can be of the same material or different materials as each other. The material(s) of the metalens (e.g., substrate and/or metasurface) and/or the refractive lens can be selected to have specific optical properties (e.g., in refractive index, transmittance, dispersion, birefringence). The material(s) can include glass and/or plastic. The glass can include fluoride, or be free of fluoride (e.g., less than 3%, 1%, 0.1% or other percentage value). The material(s) of the metalens and the refractive lens can be selected such to satisfy a level of optical dispersion (e.g., selected to correct or avoid chromatic aberration), e.g., when the metalens and the refractive lens are coupled or operating together. For example, the metalens can be glass and the refractive lens can be plastic, or vice versa. The refractive lens can include different types of glasses or plastics. FIGS. 7(a)-7(c) shows design and performance of a super superachromatic hybrid lens, according to some embodiments. FIG. 7(a) shows a layout of the super superachromatic metasurface-refractive lens design. Such extreme chromatic aberration correction is unprecedented in conventional refractive optics. It covers the wavelength region from 350 nm to 2400 nm. FIG. 7(b) shows a focal length shift with and without the metasurface as a function of wavelength. There are six wavelengths that have the same focal length. For the case without metasurface, its focal length shift is more than two orders of magnitude larger. FIG. 7(c) shows a root-mean-square wavefront error of the super superachromatic metasurface-refractive lens

One glass pair of Schott glasses: S-NSL36 and N-LASF41 gives large refractive index difference of about 0.3 and therefore was chosen to design the lens (NA=about 0.08, diameter=about 4 mm) shown in FIG. 7(a). This design manages to exhibit six wavelengths that display the same focal length shift across the bandwidth of 350 nm to 2400 nm, as seen in FIG. 7(b), a property that has not been observed in refractive or diffractive optics before. Also, the design with and without the inclusion of a metasurface in FIG. 7(b) was compared, where the focal shift with the metasurface was about 14 μm in the bandwidth of 350 and 2400 nm, while without the metasurface the focal shift is observed to be up to two orders of magnitude larger, at about 1.35 mm. This unique design is also capable of displaying diffraction limited focusing across the bandwidth of about 350 nm to about 2400 nm for up to 8° field of view, while displaying diffraction limited focusing across about 440 to about 2400 nm at 10° field of view, as shown in FIG. 7(c). However, as mentioned before, the glass combination alone cannot display such properties and would involve the incorporation of a designed metasurface that is able to satisfy dispersion conditions up to the fifth order derivative of dispersion across the radius of the lens.

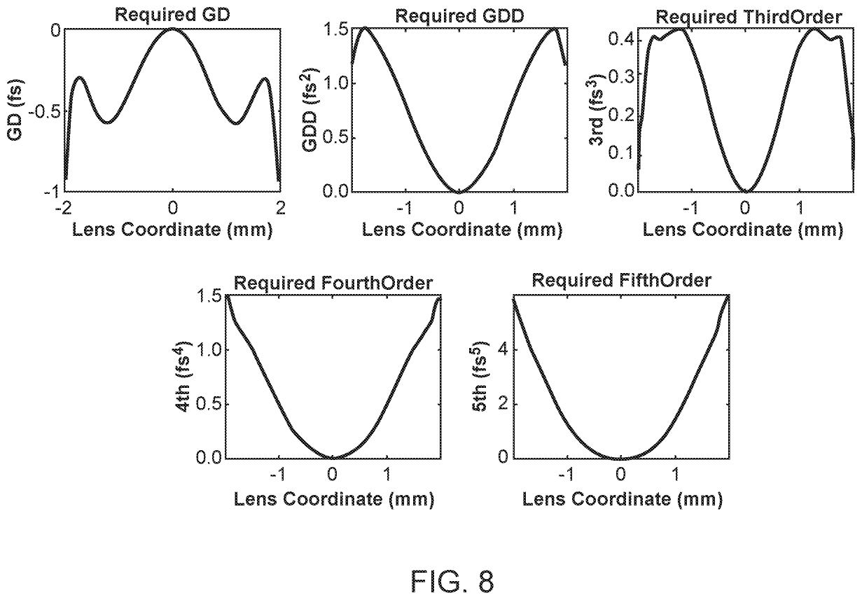

Certain conditions of the metasurface for such an intricate design is displayed in FIG. 8, showing the phase dispersion profile that should be fulfilled by the metasurface in order to achieve super superachromatic properties. FIG. 8 shows certain dispersion profiles of the metasurface shown in FIG. 7(a). The figure displays specified group delay, group delay dispersion, 3^{rd} order dispersion, 4^{th} order dispersion and 5^{th} order dispersion across the center of the metasurface depicted in FIG. 7(a). The parameters of the refractive lens are summarized in Table III below.

TABLE III
Summary of parameters of the refractive lens in FIG. 7(a).
Super Super superachromat

| | Surface 1 | Surface 2 | Surface 3 |
|---|---|---|---|
| c | 1/5.015 | −1/4.175 | 1/67.248 |
| a₁ | −0.010 | | −0.019 |
| a₂ | 1.497 × 10⁻³ | | 1.481 × 10⁻³ |
| a₃ | 9.254 × 10⁻⁵ | | −7.523 × 10⁻⁴ |
| a₄ | 2.420 × 10⁻⁵ | | 6.554 × 10⁻⁴ |
| a₅ | −1.085 × 10⁻⁵ | | −2.857 × 10⁻⁴ |
| a₆ | 2.968 × 10⁻⁶ | | 6.940 × 10⁻⁵ |
| a₇ | −3.384 × 10⁻⁷ | | −8.595 × 10⁻⁶ |
| a₈ | 9.722 × 10⁻⁹ | | 4.058 × 10⁻⁷ |

2.008-mm-thick S-NSL36 and 3.785-mm-thick N-LASF41

Thus, the present disclosure provides for, amongst other things, a general design principle of hybrid refractive-metasurface lenses and examples of apochromatic to super superachromatic hybrid lenses. The design is based on engineering metasurface dispersion, judicious glass selection and lens design to compensate dispersion values up to 5^{th}-order for unprecedented achromatic optics composed of a doublet refractive lens and a metasurface (and, for example, omitting use of a second lens). The design is particularly useful in the mid- and far-infrared regions where there is no glass available to correct chromatic aberrations.

In some embodiments, a metasurface includes a substrate and multiple nanoscale elements disposed on the substrate. The nanoscale elements define an angle-dependent phase profile that imparts a wavevector that varies depending on angles of incidence.

In some embodiments, a cross-section of at least one nanoscale element is rectangular or other polygonal shape. In some embodiments, a cross-section of at least one nanoscale element is elliptical or circular. In some embodiments, a cross-section of nanoscale elements can have a 2-fold rotational symmetry, or more generally, an n-fold rotational symmetry where n is an integer that is 2 or greater than 2.

In some embodiments, nanoscale elements are composed of a semiconductor, an oxide (e.g., a metal or non-metal oxide), a nitride (e.g., a metal or non-metal nitride), a sulfide (e.g., a metal or non-metal sulfide), a pure element, or a combination of two or more of these.

In some embodiments, a substrate is transparent in the visible spectrum, such as a polymer substrate, a glass substrate or one including fused silica. Suitable substrates that are transparent in the visible spectrum can have a light transmittance of at least about 40%, at least about 50%, at least about 60%, at least about 70%, at least about 80%, at least about 85%, at least about 90%, or at least about 95%, over the visible spectrum or a design or working wavelength in the visible spectrum.

In some embodiments, a substrate is curved or flexible, which offer alternative functionalities, for example to adjust the image distance to the eye or to focus light.

In some embodiments, nanoscale elements include a dielectric material. Examples of suitable dielectric materials include metal and non-metal oxides (such as an oxide of aluminum (e.g., Al₂O₃), silicon (e.g., SiO₂), hafnium (e.g., HfO₂), zinc (e.g., ZnO), magnesium (e.g., MgO), or titanium (e.g., TiO₂)), metal and non-metal nitrides (such as nitrides of silicon (e.g., Si₃N₄), boron (e.g., BN), or tungsten (e.g., WN)), metal and non-metal sulfides, and pure elements (e.g., silicon for operation at near-infrared and mid-infrared wavelengths).

In some embodiments, nanoscale elements have aspect ratios (e.g., height/width) greater than about one, such as at least about 1.5:1, at least about 2:1, at least about 3:1, at least about 4:1, or at least about 5:1, and up to about 10:1 or greater, or up to about 20:1 or greater. In some embodiments, geometric dimensions (e.g., height/width/length or diameter/height) of nanoscale elements are sub-wavelength, such as about 800 nm or less, about 700 nm or less, or about 600 nm or less.

In some embodiments, nanoscale elements are slanted nanopillars with a nonzero slant angle with respect to a surface normal of a metasurface grating. In some embodiments, the nonzero slanted angle is about 1 degree or greater, about 2 degrees or greater, about 5 degrees or greater, or about 10 degrees or greater.

As used herein, the singular terms “a,” “an,” and “the” may include plural referents unless the context clearly dictates otherwise.

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of embodiments of this disclosure are not deviated by such arrangement.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, two numerical values can be deemed to be “substantially” the same if a difference between the values is less than or equal to ±10% of an average of the values, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific embodiments thereof, these descriptions and illustrations do not limit the present disclosure. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

1. An optical device comprising:
a substrate;
a single-layer metasurface disposed on the substrate; and
a refractive lens,
wherein the single-layer metasurface and the refractive lens are configured to bring at least five distinct wavelengths of light to focus on a same plane.

2. The optical device of claim 1, wherein the single-layer metasurface and the refractive lens are configured to bring at least six distinct wavelengths of light to focus on the same plane.

3. The optical device of claim 1, wherein the single-layer metasurface and the refractive lens are configured to bring the at least five distinct wavelengths of light to focus on the same plane, at least along an optical axis of the refractive lens or off the optical axis of the refractive lens.

4. The optical device of claim 1, wherein the refractive lens includes a glass, and the glass is free of fluoride.

5. The optical device of claim 1, wherein the refractive lens includes a plastic.

6. The optical device of claim 1, wherein a material of the lens is different from a material of the metasurface.

7. The optical device of claim 1 wherein a material of the refractive lens has zero n′_{g} over a wavelength range of interest and the single-layer metasurface minimizes group delay and group delay dispersion.

8. The optical device of claim 1, wherein the at least five distinct wavelengths are in at least one of an infrared spectrum, a visible spectrum, or an ultraviolet spectrum.

9. The optical device of claim 1, wherein the refractive lens comprises at least one of a singlet lens or a doublet lens.

10. An optical device, comprising:
a substrate;
a metasurface disposed on the substrate; and
a lens,
wherein the metasurface and the lens are configured to provide super superachromatic focusing.

11. The optical device of claim 10, wherein the metasurface and the lens are configured to provide super superachromatic focusing.

12. The optical device of claim 10, wherein the metasurface and the lens are configured to bring at least five distinct wavelengths of light to focus on a same plane.

13. The optical device of claim 12, wherein the metasurface and the lens are configured to provide super superachromatic focusing at least along an optical axis of the lens or off the optical axis of the lens.

14. The optical device of claim 12, wherein a material of the lens is different from a material of the metasurface.

15. The optical device of claim 12, wherein the at least five distinct wavelengths are in at least one of an infrared spectrum, a visible spectrum, or an ultraviolet spectrum.

16. The optical device of claim 10, wherein the metasurface and the lens are configured to bring at least six distinct wavelengths of light to focus on a same plane.

17. The optical device of claim 10, wherein the lens includes a glass, and the glass is free of fluoride.

18. The optical device of claim 10, wherein the lens includes a plastic.

19. The optical device of claim 10, wherein the lens comprises a singlet lens.

20. The optical device of claim 10, wherein the lens comprises a doublet lens.
